(19) United States
(12) Patent Application Publication
(10) Pub. No.: US 2023/0252688 A1
(43) Pub. Date: Aug. 10, 2023

(54) METHOD AND APPARATUS FOR DISPLAYING MAP AND CAMERA CAPTURING RANGE

(71) Applicant: HANWHA TECHWIN CO., LTD., Seongnam-si (KR)

(72) Inventor: Kyoung Jeon JEONG, Seongnam-si (KR)

(73) Assignee: HANWHA TECHWIN CO., LTD., Seongnam-si (KR)

(21) Appl. No.: 18/080,664

(22) Filed: Dec. 13, 2022

(30) Foreign Application Priority Data
Feb. 8, 2022 (KR) 10-2022-0016433
Jul. 22, 2022 (KR) 10-2022-0091155

(51) Int. Cl. G06T 11/00

(52) U.S. Cl. CPC G06T 11/00; G06T 2200/24

(57) ABSTRACT

Provided are a simulation apparatus for providing a simulation view screen, and a simulation method using the same. An operation method of the simulation apparatus for providing a simulation view screen related to a field of view of a camera, includes obtaining camera performance information, map information, and camera setting information, determining first user interface (UI) information for displaying a map image in a first UI region, based on the map information, determining a second UI region corresponding to second UI information, based on the map information, and determining the second UI information for displaying the field of view in the second UI region, based on the camera performance information and the camera setting information.

### CROSS-REFERENCE TO RELATED APPLICATIONS

This application is based on and claims priority under 35 U.S.C. § 119 to Korean Patent Application No. 10-2022-0016433, filed on Feb. 8, 2022, and Korean Patent Application No. 10-2022-0091155, filed on Jul. 22, 2022, in the Korean Intellectual Property Office, the disclosures of which are incorporated by reference herein in their entirety.

### BACKGROUND

### 1. Field

The disclosure relates to a simulation apparatus for providing a simulation view screen, and a simulation method using the same.

### 2. Description of the Related Art

A terminal is an electronic device connected to a computing device through a network to input and output data in a computing system. Such a terminal is implemented in a form of a multimedia player providing visual content to a user through a display. With fast development of the technology and the gradual advancement and subdivision of the industry, numerous types of terminals corresponding to different purposes of use, are being developed.

Various attempts are being applied to develop multimedia players with complex functions. Also, in line with the rapid development of communication technology, functions of terminals are ever expanding, and in this regard, various user interfaces (UIs) and various functions using the UIs are being provided to users. In other words, terminals provide a UI screen to users through the display and changes the UI screen in real time, according to a user input, such as touch, tap, drag, and click. Accordingly, users may simply operate the terminal or receive information displayed on the terminal quickly and accurately.

The aforementioned background technology is technical information possessed by the inventor for derivation of the disclosure or acquired by the inventor during the derivation of the disclosure, and is not necessarily prior art disclosed to the public before the application of the disclosure.

### SUMMARY

Provided are a simulation apparatus for providing a simulation view screen, and a simulation method using the same.

Additional aspects will be set forth in the description which follows and will be apparent from the description, or may be learned by practice of the present disclosure.

According to an aspect of the disclosure, an operation method of a simulation apparatus for providing a simulation view screen related to a field of view of a camera, includes obtaining camera performance information, map information, and camera setting information, determining first user interface (UI) information for displaying a map image in a first UI region, based on the map information, determining a second UI region corresponding to second UI information, based on the map information, and determining the second UI information for displaying the field of view in the second UI region, based on the camera performance information and the camera setting information.

The map information may include a map image size and a map scale, and the camera setting information may include camera position information.

The determining of the second UI region may include determining a map size based on the map image size and the map scale, and determining the second UI region based on the map size.

The determining of the second UI information may include determining a maximum working distance of the camera within the second UI region, based on the map image size and the map scale, and calculating the field of view based on the maximum working distance.

The maximum working distance may be a diagonal distance of the second UI region or an outermost distance that is largest from among straight distances from a position corresponding to the camera position information to boundaries of the second UI region.

The second UI region may overlay at least a portion of the first UI region

According to another aspect of the disclosure, a simulation apparatus for providing a simulation view screen related to a field of view of a camera, includes a communicator configured to transmit and receive a signal, an information processor configured to obtain camera performance information and camera setting information, a first user interfacer configured to determine first UI information for displaying a map image in a first UI region, based on the map information, and a second user interfacer configured to determine a second UI region corresponding to second UI information, based on the map information, and determine the second UI information for displaying a field of view in the second UI region, based on the camera performance information and the camera setting information.

The map information may include a map image size and a map scale.

The camera setting information may include camera position information.

The second user interfacer may be further configured to determine a map size based on the map image size and the map scale, and determine the second UI region based on the map size.

The second user interfacer may be further configured to determine a maximum working distance of the camera in the second UI region, based on the map image size and the map scale, and calculate the field of view based on the maximum working distance.

The maximum working distance may be a diagonal distance of the second UI region or an outermost distance that is largest from among straight distances from a position corresponding to the camera position information to boundaries of the second UI region.

### BRIEF DESCRIPTION OF THE DRAWINGS

The above and other aspects, features, and advantages of the present disclosure will be more apparent from the following description taken in conjunction with the accompanying drawings, in which:

FIG. 1 is a diagram of a simulation system according to the present disclosure;

FIG. 2 is a block diagram of a configuration of a simulation apparatus in a simulation system, according to the present disclosure;

FIG. 3 illustrates an example of a user interface (UI) screen corresponding to a map image displayed on a simulation apparatus in a simulation system, according to a the present disclosure;

FIG. 4 illustrates an example of a UI screen corresponding to a field of view displayed on a simulation apparatus in a simulation system, according to the present disclosure;

FIG. 5 illustrates an example of a UI screen displayed on a simulation apparatus in a simulation system, according to the present disclosure;

FIG. 6 illustrates an example of a UI screen displaying a virtual object on a simulation apparatus in a simulation system, according to the present disclosure; and

FIG. 7 is a flowchart of an operation method of a simulation apparatus in a simulation system, according to the present disclosure.

### DETAILED DESCRIPTION

Reference will now be made in detail, examples of which are illustrated in the accompanying drawings, wherein like reference numerals refer to like elements throughout. In this regard, the present disclosure may have different forms and should not be construed as being limited to the descriptions set forth herein. Accordingly, the present disclosure is merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Terms used in the disclosure are used only to describe a specific example, and are not be intended to limit the scope of other examples. An expression used in the singular may encompass the expression in the plural, unless it has a clearly different meaning in the context. Terms used herein, including technical or scientific terms, may have the same meaning as commonly understood by one of ordinary skill in the art described in the disclosure. Among terms used in the disclosure, terms defined in a general dictionary may be interpreted as having the same or similar meanings as those in the context of the related technology, and unless explicitly defined in the disclosure, the terms are not interpreted in ideal or excessively formal meanings. In some cases, even terms defined in the disclosure cannot be interpreted to exclude examples of the present disclosure.

In the present disclosure described below, a hardware approach is described as an example. However, because the present disclosure includes technology using both hardware and software, the present disclosure do not exclude a software-based approach.

A user who is to purchase and install a camera may use a simulation apparatus to identify a capturable region through the camera. Here, the simulation apparatus denotes a terminal that displays, on a display, a simulation view screen related to a field of view (FoV) captured by the camera. In other words, a range recognizable by the camera may vary depending on a performance of the camera itself, a position where the camera is arranged, and the like, and the simulation apparatus may provide information about the FoV of the camera to the user, considering camera information and an environment.

When the FoV of the camera is identified in various directions, it is difficult for the simulation apparatus to identify view screens in various directions simultaneously. The simulation apparatus may display one view screen related to one direction of the FoV of the camera through a user interface (UI) screen, and when the user changes a simulation condition, change content displayed on the one view screen. In other words, the user is able to only identify a view screen in one direction of an FoV, and is difficult to identify view screens related to several directions simultaneously. According to the disclosure, the view screens related to the several directions may be quickly and accurately identified through improvement of the UI screen of the simulation apparatus.

The disclosure relates to a simulation system for providing a view screen related to an FoV of a camera. More particularly, the disclosure relates to a technology for simulating view screens related to a plurality of directions of an FoV of a camera and displaying the same on a display, according to an environment where the camera is arranged and a performance of the camera.

Hereinafter, the present disclosure will be described in detail with reference to the accompanying drawings such that one of ordinary skill in the art may easily implement the disclosure. However, the technical idea of the disclosure may be implemented by being modified in various forms, and thus is not limited to examples described in the present specification. While describing the present specification, detailed descriptions about a related well-known technology are omitted when it is determined that describing the well-known technology in detail may blur the gist of the technical idea of the disclosure. Same reference numerals are assigned to same or similar elements, and redundant descriptions thereof are omitted.

When it is described that an element is “connected” to another element in the present specification, the element may not only be “directly connected” to the other element, but may also be “indirectly connected” to the other element with another element in between. When an element “includes” or “comprises” another element, the element may further include another element instead of excluding the other element, unless otherwise stated.

Some examples may be described by functional block configurations and various processing operations. Some or all of these functional blocks may be implemented by various numbers of hardware and/or software configurations that perform particular functions. For example, the functional blocks of the disclosure may be implemented by one or more microprocessors or by circuit configurations for a certain function. The functional blocks of the disclosure may be implemented in various programming or scripting languages. The functional blocks of the disclosure may be implemented by algorithms executed in one or more processors. A function performed by a functional block of the disclosure may be performed by a plurality of functional blocks, or functions performed by a plurality of functional blocks of the disclosure may be performed by one functional block. In addition, the disclosure may employ general techniques for electronic environment setting, signal processing, and/or data processing.

Also, in the disclosure, the expression “greater than” or “less than” is used to determine whether a specific condition is satisfied or fulfilled, but the expression is only an example and another expression “equal to or greater than” or “equal to or less than” is not excluded. A condition described to be “equal to or greater than” may be replaced by “greater than”, a condition described to be “equal to or less than” may be replaced by “less than”, and a condition described to be “equal to or greater than, and less than” may be replaced by “greater than, and equal to or less than”. Also, in the disclosure, a camera is a device that captures an image, and the image indicates an image in which information is reified to be visually captured by a medium or by rays arranged on a plane or in a space. According to the present disclosure, examples of the image may include a still image and a moving image.

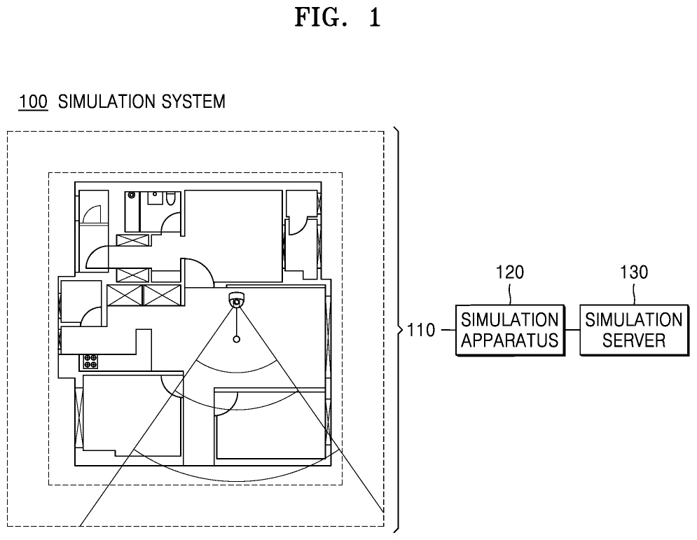

FIG. 1 is a diagram of a simulation system 100 for providing a view screen related to an FoV of a camera, according the present disclosure. The simulation system 100 may include a simulation apparatus 120 and a simulation server 130. Hereinafter, for convenience of descriptions, the simulation server 130 and the simulation apparatus 120 are distinguished between each other, but the simulation server 130 and the simulation apparatus 120 may be comprised of substantially the same components. For example, software implemented by a processor of the simulation server 130 may be transmitted to the simulation apparatus 120 and the simulation apparatus 120 may operate the software.

FIG. 1 illustrates the simulation apparatus 120, the simulation server 130, and a simulation view screen 110 provided by the simulation apparatus 120.

The simulation view screen 110 indicates visual content displaying a region captured by a camera. In detail, the simulation view screen 110 may indicate a UI screen displaying a capturing range of the region captured by the camera, taking into account the performance of the camera and the position where the camera is arranged. The capturing range may be changed in relation to the performance of the camera and the position where the camera is arranged. The simulation view screen 110 may provide a map (map image) of a region where the camera is to be installed. The simulation view screen 110 may provide the capturing range of the camera at the position where the camera is to be installed, on the map image. A user may visually identify the region captured by the camera by identifying the position of the camera, the capturing range, and the map from the simulation view screen 110. A plurality of UI screens may be overlapped and displayed in the simulation view screen 110.

Referring to FIG. 1, the camera may be positioned in the simulation view screen 110 and the capturing range of the camera may be determined by the performance of the camera. Also, the camera may be positioned in the map image. The user may identify, in real time, a relationship between the map and the capturing range of the camera while moving the camera.

The simulation server 130 may be implemented as a computer device or a plurality of computer devices, which communicate with the simulation apparatus 120 through a network to provide a command, a code, a file, content, and a service. The simulation server 130 may provide information or data to the simulation apparatus 120 in response to a request. The simulation apparatus 120, which is controlled by at least one program, may access the simulation server 130 and receive a service or content provided by the simulation server 130. According to the present disclosure, the simulation server 130 may transmit camera performance information to the simulation apparatus 120.

The simulation server 130 may transmit, to the simulation apparatus 120, data for the simulation apparatus 120 to generate the simulation view screen 110 and display the same on a display to the user.

The simulation apparatus 120 indicates an apparatus for displaying the capturing range of the camera as visual content. In detail, the simulation apparatus 120 indicates a terminal that generates the simulation view screen 110 and provides the simulation view screen 110 to the user by displaying the simulation view screen 110 on the display. The user may input information about the position of the camera to the simulation apparatus 120 to generate the simulation view screen 110. Then, the simulation apparatus 120 may display the generated simulation view screen 110 on the display.

The simulation apparatus 120 includes a fixed terminal or a mobile terminal implemented as a computer device. According to the present disclosure, the simulation apparatus 120 may include a smart phone, a mobile phone, a navigation device, a computer, a laptop computer, a digital broadcasting terminal, a personal digital assistant (PDA), a portable multimedia player (PMP), and a table personal computer (PC). The simulation apparatus 120 may communicate with the simulation server 130 through a network by using a wireless or wired communication method.

Hereinafter, a method by which the simulation apparatus 120 generates the simulation view screen 110 and a method of changing content being displayed on the simulation view screen 110 will be described in detail.

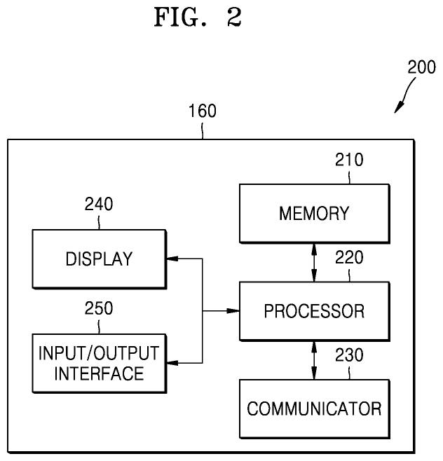

FIG. 2 is a block diagram of a configuration 200 of the simulation apparatus 120 in the simulation system 100, according to the present disclosure. Terms such as “unit” and “-er/or” described below denote a unit that processes at least one function or operation, which may be implemented in hardware or software, or implemented in a combination of hardware and software. The simulation apparatus 120 may include a memory 210, a processor 220, a communicator 230, an input/output interface 250, and a display 240. When the simulation server 130 and the simulation apparatus 120 have substantially the same configuration, an information processor, a first user interfacer, and a second user interfacer may be implemented as software by a processor of the simulation server 130 and transmitted to the simulation apparatus 120.

The memory 210 temporarily or permanently stores data, such as a basic program, an application program, and configuration information, for operations of the simulation apparatus 120. The memory 210 may include a permanent mass storage device, such as a random-access memory (RAM), a read-only memory (ROM), or a disk drive, but the disclosure is not limited thereto. Such software components may be loaded from a computer-readable recording medium separate from the memory 210, by using a drive mechanism. Such a separate computer-readable recording medium may include a computer-readable recording medium such as a floppy drive, a disk, a tape, a DVD/CD-ROM drive, or a memory card. According to the present disclosure, the software components may be loaded into the memory 210 through the communicator 230, instead of the computer-readable recording medium. Also, the memory 210 may provide the stored data upon request by the processor 220. According to the present disclosure, the memory 210 may store camera performance information, map information, and camera setting information. Also, the memory 210 may store the simulation view screen 110 generated by the simulation apparatus 120.

The processor 220 controls overall operations of the simulation apparatus 120. For example, the processor 220 may control the communicator 230 to transmit and receive signals. Also, the processor 220 may be configured to process a command of a computer program by performing basic arithmetic, logic, and input/output operations. The command may be provided to the processor 220 by the memory 210 or the communicator 230. For example, the processor 220 may be configured to execute a received command according to a program code stored in a recording device, such as the memory 210.

According to the present disclosure, the processor 220 may obtain the camera performance information, receive from a user, the map information and the camera setting information in order to determine a simulation view screen, determine first UI information based on the map information in order to display a map image in a first UI region, and determine based on the map information, a second UI region corresponding to second UI information. Also, the processor 220 may determine the second UI information, based on the second UI region, the camera performance information, and the camera setting information, in order to display an FoV. In detail, the processor 220 may control the simulation apparatus 120 to perform operations described above.

The processor 220 may determine a map size based on a map image size and a map scale, and determine the second UI region based on the map size.

The processor 220 may determine a maximum working distance of a camera in the second UI region, based on the map image size and the map scale, and calculate the FoV based on the maximum working distance.

The processor 220 may obtain virtual object information and generate the second UI information, based on the second UI region and the virtual object information, in order to display the FoV in the second UI region.

Such a processor 220 may be implemented with a single central processing unit (CPU) or a plurality of CPUs (or a digital signal processor (DSP) or a system-on-chip (SoC)). The processor 220 may be implemented with a DSP for processing a digital signal, a microprocessor, or a time controller (TCON). However, the processor 220 is not limited thereto, and may include one or more of a CPU, a micro controller unit (MCU), a micro processing unit (MPU), a controller, an application processor (AP), a communication processor (CP), and an ARM processor, or may be defined by such terms.

The communicator 230 performs functions to transmit and receive a signal through a wireless channel. The communicator 230 or a part thereof may be referred to as a transmitter, a receiver, or a transceiver. The communicator 230 may provide a function for the simulation apparatus 120 and another at least one node to communicate with each other through a communication network. According to the present disclosure, when the processor 220 of the simulation apparatus 120 has generated a request signal according to a program code stored in a recording device such as the memory 210, the request signal may be transmitted to the other at least one node through the communication network under control of the communicator 230. Vice versa, a control signal, a command, content, or a file provided under control of a processor of the other at least one node may be received by the simulation apparatus 120 through the communicator 230. According to the present disclosure, the communicator 230 may receive input information required to generate the simulation view screen 110. Also, the communicator 230 may transmit the simulation view screen 110 to an external device.

The input/output interface 250 may be a unit for an interface with a separate input/output device. Here, an input device may include a device such as a keyboard or a mouse, and an output device may include a device such as a display for displaying an image. As another example, the input/output interface 250 may be a unit for an interface with a device in which functions for input and output are integrated, such as a touch screen. In detail, while the processor 220 of the simulation apparatus 120 processes a command of a computer program loaded onto the memory 210, a service screen or content configured by using data provided by a server may be displayed on a display through the input/output interface 250. According to the present disclosure, the input/output interface 250 may include a unit for an interface with the display 240. The input/output interface 250 may receive a user input for a web browsing window displayed on the display 240, and receive, from the processor 220, output data to be output through the display 240 in response to the user input.

The display 240 indicates at least one display module. Each of the at least one display module included in the display 240 may display individually independent content or the display modules may display a single piece of content. According to the present disclosure, the at least one display module included in the display 240 may include physically separated multi-displays or a physically combined multi-display, or may be a display in which one screen may be split.

A user who is to install a camera at a fixed position and capture an image may identify a capturable range of the camera considering a map by using the simulation apparatus 120 before purchasing the camera. According to the present disclosure, the user may use the simulation apparatus 120 to identify the capturable range of the camera installed at a specific height, and the simulation apparatus 120 may provide, to the user, a simulation view screen related to an FoV of the camera considering map information, camera performance information, and camera setting information.

According to the present disclosure, when the simulation apparatus 120 has the same configuration as the simulation server 130, functions or operations of the processor 220 may be implemented by software, such as an information processor, a first user interfacer, and a second user interfacer by the simulation server 130, and the operations may be processed as the information processor, the first user interfacer, and the second user interfacer are transmitted to the simulation apparatus 120 through the communicator 230.

The information processor may obtain at least one piece of information from among the camera performance information, the map information, the camera setting information, and the virtual object information.

The first user interfacer may determine the first UI information for displaying a map image in the first UI region, based on the map information.

The second user interfacer may determine the second UI region corresponding to the second UI information, based on the map information, and determine the second UI information for displaying the FoV in the second UI region, based on the camera performance information and the camera setting information.

The second user interfacer may determine a map size based on a map image size and a map scale, and determine the second UI region based on the map size.

The second user interfacer may determine a maximum working distance of the camera in the second UI region, based on the map image size and the map scale, and calculate the FoV based on the maximum working distance.

The second user interfacer may generate the second UI information for displaying the FoV in the second UI region, based on the second UI region and the virtual object information.

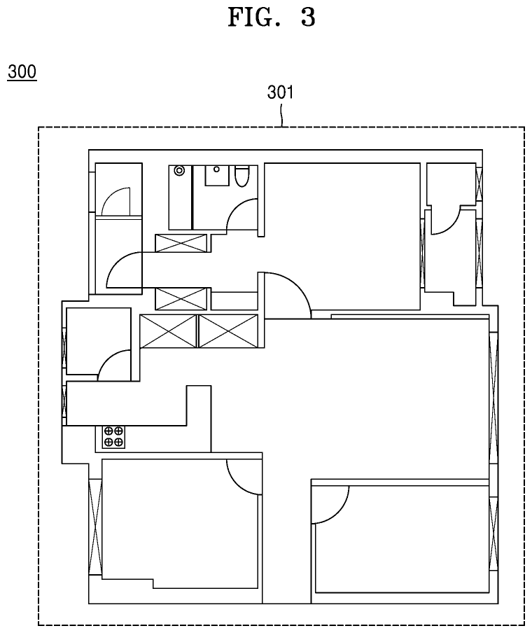

FIG. 3 illustrates an example of a UI screen corresponding to a map image displayed on the simulation apparatus 120 in the simulation system 100, according to the present disclosure.

A user may input map information for simulation to the simulation apparatus 120. The simulation apparatus 120 may receive, from the user, the map information so as to generate first UI information to be displayed on a display. The map information may be map information of a region where a camera is to be installed. The map information may include the map image, a map image size, and a map scale. According to the present disclosure, the simulation apparatus 120 may obtain, from the simulation server 130, a map corresponding to space information input by the user. The simulation apparatus 120 may obtain, from the simulation server 130, the map image, the map image size, and the map scale.

Referring to FIG. 3, the simulation apparatus 120 may determine the first UI information for displaying the map image, and display a first UI screen 300 providing the first UI information on one region of the display. In detail, the simulation apparatus 120 may determine the first UI information in order to display the map image included in the map information provided by a user. The size of a map image may be limited to a first UI region 301 providing or displaying the first UI information in the first UI screen 300. In the present specification, a screen or region corresponding to certain information may denote a screen or region providing (displaying) the certain information.

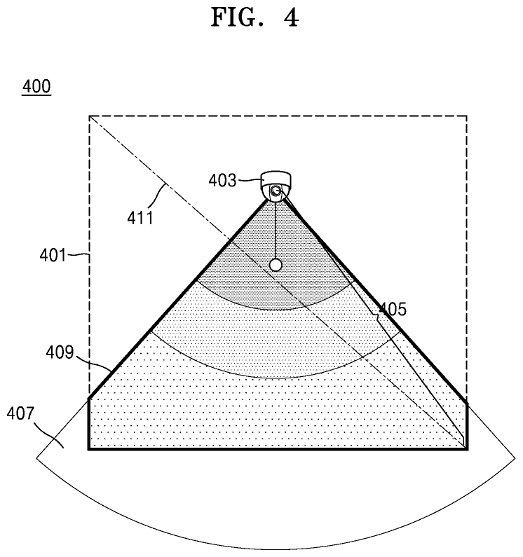

FIG. 4 illustrates an example of a second UI screen 400 providing an FoV displayed on the simulation apparatus 120 in the simulation system 100, according to the present disclosure.

A user may select, from the simulation apparatus 120, a camera to be simulated on a map. The simulation apparatus 120 may request the simulation server 130 for information of the camera selected by the user, and the simulation apparatus 120 may receive camera performance information from the simulation server 130. The camera performance information may include information about a camera resolution, an image sensor size, and a focal length range.

Also, the user may input camera setting information for simulation to the simulation apparatus 120. The simulation apparatus 120 may receive, from the user, the camera setting information so as to generate second UI information to be displayed on a display. The camera setting information may include at least one of a focal length, an installation height, a tilt angle, and camera position information. For example, the focal length may denote a focal length set within the focal length range included in the camera performance information, and the installation height may denote a height at which the camera is to be installed from the surface of the earth. The tilt angle may denote an angle between the surface of the earth and a direction in which the camera captures an image. In addition, the camera position information may denote information about position of the camera in relation to the map.

Referring to FIG. 4, the simulation apparatus 120 may determine a second UI region 401 corresponding to second UI information in the second UI screen 400, based on map information, and determine the second UI information regarding an FoV to be displayed in the second UI region 401, based on the second UI region 401, the camera performance information, and the camera setting information. Also, the simulation apparatus 120 may display the second UI screen 400 corresponding to the second UI information in one region of the display.

An FoV and/or a capturing range of a camera 403 may be displayed as the second UI information in the limited second UI region 401 of the second UI screen 400. For example, the simulation apparatus 120 may determine a map size that is the actual size of the map, based on a map scale and a map image size included in map information, and determine the second UI region 401 corresponding to the second UI information to have a size greater than or equal by a specific ratio in comparison to the map image size, based on the map size and the map image size. For example, the simulation apparatus 120 may determine the second UI region 401 corresponding to the second UI information to be at least 30% greater than the map image size. Accordingly, the second UI region 401 corresponding to the second UI information may be 1.3 times of the map image size.

Alternatively, the simulation apparatus 120 may adaptively determine the second UI region 401 corresponding to the second UI information, based on the map image size. For example, when the map image size is less than a threshold value, the simulation apparatus 120 may determine the second UI region 401 corresponding to the second UI information to have a size greater than or equal by a ratio of first value in comparison to the map image size, and when the map image size is equal to or greater than the threshold value, the simulation apparatus 120 may determine the second UI region 401 corresponding to the second UI information to have a size greater than or equal by a ratio of second value in comparison to the map image size. Here, the second ratio is less than the first ratio.

As such, when the second UI region 401 corresponding to the second UI information is determined in consideration of the map image size and the map size, calculations of the FoV and capturing range may be effectively limited while displaying the FoV and capturing range of the camera 403 to the user.

Also, the simulation apparatus 120 may display the second UI screen 400 in one region of the display. According to the present disclosure, the second UI screen 400 may overlay the first UI screen 300.

The simulation apparatus 120 may receive the camera setting information including the camera position information while the user varies an arrangement of an icon of the camera 403 according to a user input, such as touch, tap, drag, or click.

The simulation apparatus 120 may determine a maximum working distance 405 based on the second UI region 401 of the second UI screen 400. The maximum working distance 405 may denote a maximum distance in which the FoV of the camera 403 can be displayed. The maximum working distance 405 may be determined according to the size of the second UI region 401. For example, upon determining the maximum working distance 405, the simulation apparatus 120 may calculate the FoV limited by the maximum working distance 405, and display only the FoV limited by the maximum working distance 405 in the second UI region 401. Throughput is decreased because the simulation apparatus 120 only needs to calculate and display the FoV, limited by the maximum working distance 405, within the FoV of the camera 403 displayable in the second UI screen 400.

The simulation apparatus 120 may calculate an FoV of a camera according to a working distance. The FoV of the camera may be calculated according to Equation 1.

$$FOV = \frac{SensorSize ( H ) or ( V )}{f} \times WD \qquad [ Equation 1 ]$$

FOV denotes an FoV of a camera, SensorSize denotes a horizontal (H) or vertical (V) size of an image sensor, f denotes a focal length, and WD denotes a working distance.

Also, the simulation apparatus 120 may calculate a pixel per meter (PPM) according to a working distance, based on the FoV and camera performance information, such as a camera resolution.

The PPM may be calculated according to Equation 2.

$$PPM = \frac{ImageSize ( Width ) or ( Hight )}{FOV} \\ PPM = \frac{ImageSize ( Width ) or ( Hight )}{SensorSize ( H ) or ( V )} \frac{f}{WD} \qquad [ Equation 2 ]$$

FOV denotes an FoV, ImageSize denotes a width or height of a camera resolution, SensorSize denotes a horizontal (H) or vertical (V) size of an image sensor, f denotes a focal length, and WD denotes a working distance.

The simulation apparatus 120 may calculate an FoV and PPM for an entire working distance, based on Equation 1 and Equation 2, so as to display the FoV and PPM on the second UI screen 400, and generate the second UI information based thereon. In this case, the simulation apparatus 120 performs calculations for the entire working distance, and thus unnecessary calculations are performed.

The simulation apparatus 120 according to the present disclosure may calculate a limited FoV and a limited PPM based on the size of the second UI region 401, and generate only the second UI information to be displayed in the second UI region 401. FIG. 4 illustrates an example of an FoV 409 limited by the maximum working distance 405, being inside an FoV 407 based on an entire working distance of the camera 403. The FoV 409 is limited by the second UI region 401 and displayed as the second UI information. The simulation apparatus 120 is capable of not determining second UI information related to a portion of the the FoV 407 based on the entire working distance of the camera 403, the portion being an FoV being outside of the second UI region 401, and is capable of not displaying the second UI information in the region outside the second UI region 401. Accordingly, the simulation apparatus 120 is capable of displaying only the FoV 409 limited by the maximum working distance 405 in the second UI region 401.

A capturing range represented based on such limited FoV and PPM may be divided into perception regions based on the PPM according to the working distance. In other words, the simulation apparatus 120 may divide the capturing range into a detection region, an observation region, a recognition region, and an identification region. Such perception regions may be distinguished between each other according to colors or shades.

In detail, the simulation apparatus 120 according to the present disclosure may calculate an outermost distance having a highest value from among straight distances from a position (camera position) where the camera 403 is to be arranged to boundaries of the second UI region 401, based on the map image size, a UI region based on the map scale, and the camera position information, and determine the outermost distance as the maximum working distance 405.

The simulation apparatus 120 according to the present disclosure may determine the second UI region 401 based on the map image size and the map scale, regardless of the camera position information, and determine a diagonal distance 411 of the second UI region 401 as the maximum working distance 405.

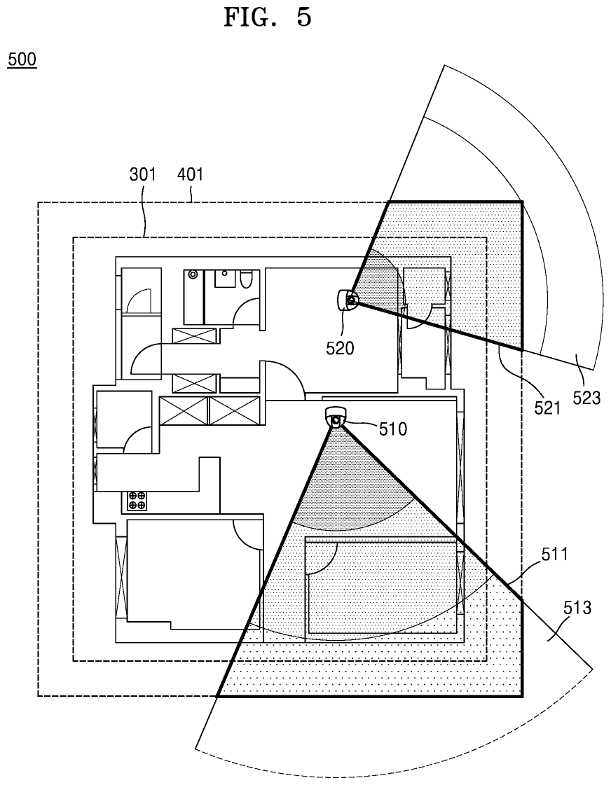

FIG. 5 illustrates an example of a UI screen 500 displayed on the simulation apparatus 120 in the simulation system 100, according to the present disclosure. Referring to FIG. 5, the simulation apparatus 120 may overlay the second UI screen 400 on the first UI screen 300. Transparency of the first UI screen 300 and/or the second UI screen 400 may be adjusted. For example, the transparency of the second UI screen 400 may be controlled, and the simulation apparatus 120 may transparently overlay the second UI screen 400 on the first UI screen 300. Here, the first UI region 301 corresponding to the first UI information may be smaller than the second UI region 401 corresponding to the second UI information.

The UI screen 500 displayed on the simulation apparatus 120 may display capturing ranges related to a plurality of cameras 510 and 520.

In detail, the simulation apparatus 120 may determine the second UI region 401 corresponding to the second UI information based on map information, and determine the second UI information for displaying FoVs of the plurality of cameras 510 and 520, based on UI regions, a plurality of pieces of camera performance information, and a plurality of pieces of camera setting information. The simulation apparatus 120 may display, within the second UI region 401 corresponding to the second UI information, FoVs 511 and 521 limited by maximum working distances, within FoVs 513 and 523 based on entire working distances of the plurality of cameras 510 and 520, as the second UI information.

The simulation apparatus 120 is capable of not performing calculations related to working distances outside the maximum working distances for the FoVs 513 and 523 based on the entire working distances of the plurality of cameras 510 and 520, and is capable of not displaying regions outside the second UI region 401.

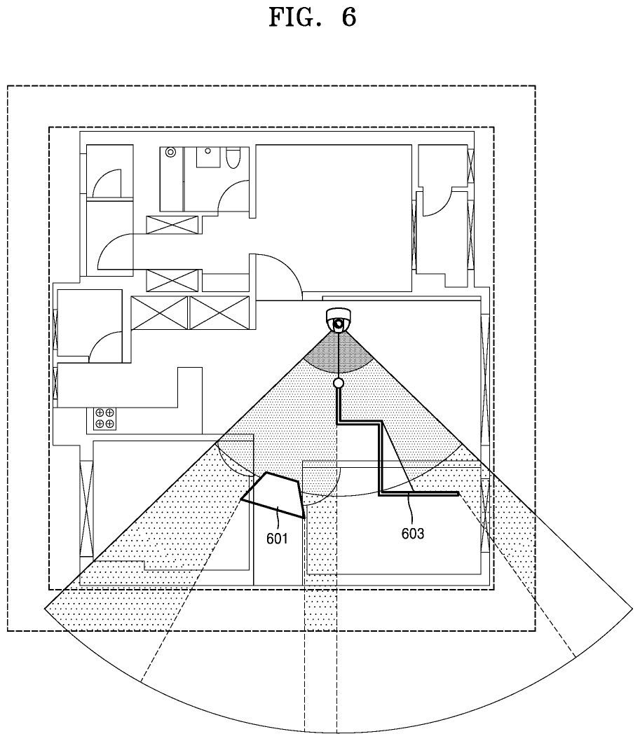

FIG. 6 illustrates an example of a UI screen displaying a virtual object on the simulation apparatus 120 in the simulation system 100, according to the present disclosure.

A user may arrange a virtual wall 603 and a virtual obstacle 601 according to a user input, such as touch, tap, drag, or click, to the simulation apparatus 120.

The user may input virtual object information to the simulation apparatus 120. For example, the user may input a size, a position, and the like of the virtual wall 603 or the virtual obstacle 601. The simulation apparatus 120 may calculate a capturing range considering the virtual object information, for example, the virtual wall 603 or the virtual obstacle 601. The simulation apparatus 120 may calculate an FoV and a PPM, and generate second UI information based thereon. At this time, the simulation apparatus 120 may calculate the FoV and the PPM based on a maximum working distance or a UI region corresponding to the second UI information, and generate the second UI information.

As shown in FIG. 6, the simulation apparatus 120 may calculate a shading range considering the virtual wall 603 or virtual obstacle 601, and display the shading range to be distinguished from the capturing range. For example, the shading range may be distinguished from the capturing range by colors or shades.

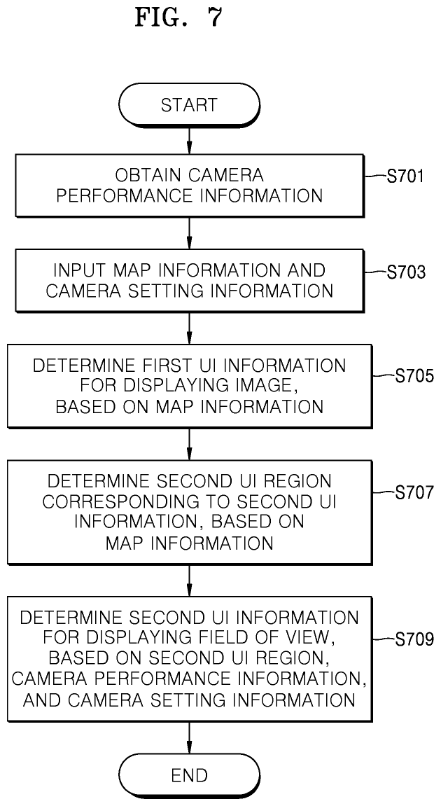

FIG. 7 is a flowchart of an operation method of the simulation apparatus 120 in the simulation system 100, according to the present disclosure. FIG. 7 illustrates the operation method of the simulation apparatus 120 for providing a simulation view screen related to an FoV of a camera.

In operation S701, the simulation apparatus 120 may obtain camera performance information. The camera performance information may include information about a camera resolution, an image sensor size, and a focal length range.

In operation S703, the simulation apparatus 120 may receive and obtain, from a user, map information and camera setting information for determining the simulation view screen. For example, the map information may include a map image size and a map scale. The camera setting information may include at least one of a focal length, an installation height, a tilt angle, and camera position information.

In operation S705, the simulation apparatus 120 may determine first UI information for displaying a map image in a first UI region, based on the map information. In detail, the simulation apparatus 120 may convert the map image based on the map scale and the map image size, and determine the first UI information for displaying the converted map image.

In operation S707, the simulation apparatus 120 may determine a second UI region corresponding to second UI information, based on the map information. For example, the simulation apparatus 120 may determine a map size based on the map image size and the map scale included in the map information, and determine the second UI region based on the map size. The simulation apparatus 120 may determine the second UI region corresponding to the second UI information to be at least 30% greater than the map image size. The second UI region corresponding to the second UI information may be 1.3 times of the map image size. Alternatively, the simulation apparatus 120 may adaptively determine the second UI region corresponding to the second UI information, based on the map image size. For example, when the map image size is less than a threshold value, the simulation apparatus 120 may determine the second UI region corresponding to the second UI information to have a size greater than or equal by a ratio of first value in comparison to the map image size, and when the map image size is equal to or greater than the threshold value, the simulation apparatus 120 may determine the second UI region corresponding to the second UI information to have a size greater than or equal by a ratio of second value in comparison to the map image size. Here, the second ratio is less than the first ratio.

In operation S709, the simulation apparatus 120 may determine the second UI information for displaying at least one of an FoV, a PPM, and perception regions. In detail, the simulation apparatus 120 may determine the second UI information for displaying the FoV, based on the second UI region corresponding to the second UI information, the camera performance information, and the camera setting information.

In operation S709, the simulation apparatus 120 according to the present disclosure may determine a maximum working distance based on the second UI region and calculate the FoV based on the maximum working distance.

In operation S709, the simulation apparatus 120 according to the present disclosure may calculate an outermost distance from a position where a camera is arranged to the second UI region corresponding to the second UI information, based on the camera position information, and determine the outermost distance as the maximum working distance.

In operation S709, the simulation apparatus 120 according to the present disclosure may determine the second UI region based on the map image size and the map scale, regardless of the camera position information, and determine a diagonal distance of the second UI region as the maximum working distance.

As a result, the simulation apparatus 120 according to the disclosure may calculate the FoV and the PPM based on the maximum working distance or the second UI region corresponding to the second UI information, and generate the second UI information. Compared to when an FoV and a PPM related to an entire working distance are calculated and second UI information is generated based thereon, amount of calculation of the simulation apparatus 120 is decreased when the second UI information is generated according to the disclosure.

When an actual distance in a map is calculated based on the map image size and the map scale as such and the second UI region is limited based on the actual distance, a capturing range of the camera may be further effectively displayed.

In addition, when the maximum working distance for calculating the FoV of the camera is determined based on the second UI region, calculation for an entire working distance is not required, and thus the FoV may be further effectively calculated.

Such a simulation apparatus 120 may adaptively calculate and display the capturing range in relation to the map size.

The effects of the present disclosure is not limited to those mentioned above, and other effects that are not mentioned may be clearly understood by one of ordinary skill in the art from the scope of claims.

It should be understood that the present disclosure described herein should be considered in a descriptive sense only and not for purposes of limitation. Descriptions of features or aspects within each example should typically be considered to be available for other similar features or aspects in other examples. While one or more examples have been described with reference to the figures, it should be understood by those of ordinary skill in the art that various changes in form and details may be made therein without departing from the spirit and scope of the disclosure as defined by the following claims.

What is claimed is:

1. A simulation method of a simulation apparatus for providing a simulation view screen related to a field of view of a camera, the simulation method comprising:
obtaining camera performance information, map information, and camera setting information;
determining first user interface (UI) information for displaying a map image in a first UI region, based on the map information;
determining a second UI region corresponding to second UI information, based on the map information; and
determining the second UI information for displaying the field of view in the second UI region, based on the camera performance information and the camera setting information.

2. The simulation method of claim 1, wherein the map information comprises a map image size and a map scale.

3. The simulation method of claim 2, wherein the camera setting information comprises camera position information.

4. The simulation method of claim 3, wherein the determining of the second UI region comprises:
determining a map size based on the map image size and the map scale; and
determining the second UI region based on the map size.

5. The simulation method of claim 3, wherein the determining of the second UI information comprises:
determining a maximum working distance of the camera within the second UI region, based on the map image size and the map scale; and
calculating the field of view based on the maximum working distance.

6. The simulation method of claim 5, wherein the maximum working distance is a diagonal distance of the second UI region or an outermost distance that is largest from among straight distances from a position of the camera included in the camera position information to boundaries of the second UI region.

7. The simulation method of claim 1, wherein the second UI region overlays at least a portion of the first UI region.

8. The simulation method of claim 1, further comprising:
obtaining virtual object information; and
generating the second UI information for displaying the field of view in the second UI region, based on the second UI region and the virtual object information.

9. A simulation apparatus of a simulation system, the simulation apparatus comprising:
a communicator configured to transmit and receive a signal;
a processor configured to obtain camera performance information, map information, and camera setting information;
a first user interfacer configured to determine first UI information for displaying a map image in a first UI region, based on the map information; and
a second user interfacer configured to determine a second UI region corresponding to second UI information, based on the map information, and determine the second UI information for displaying a field of view in the second UI region, based on the camera performance information and the camera setting information.

10. The simulation apparatus of claim 9, wherein the map information comprises a map image size and a map scale.

11. The simulation apparatus of claim 10, wherein the camera setting information comprises camera position information.

12. The simulation apparatus of claim 11, wherein the second user interfacer is further configured to determine a map size based on the map image size and the map scale, and determine the second UI region based on the map size.

13. The simulation apparatus of claim 11, wherein the second user interfacer is further configured to determine a maximum working distance of a camera in the second UI region, based on the map image size and the map scale, and calculate the field of view based on the maximum working distance.

14. The simulation apparatus of claim 13, wherein the maximum working distance is a diagonal distance of the second UI region or an outermost distance that is largest from among straight distances from a position of the camera included in the camera position information to boundaries of the second UI region.

15. The simulation apparatus of claim 9, wherein the second UI region overlays at least a portion of the first UI region.

16. A simulation apparatus of a simulation system, the simulation apparatus comprising:
a communicator configured to transmit and receive a signal;
a processor configured to obtain camera performance information, map information, and camera position information, wherein:
the map information includes a map image size and a map scale; and
the camera performance information includes a camera resolution, an image sensor size, and a focal length range;
a first user interfacer configured to determine first UI information for displaying a map image in a first UI region (301), based on the map information;
a second user interfacer configured to determine a second UI region corresponding to second UI information, based on the map information, and determine the second UI information for displaying a field of view in the second UI region, based on the camera performance information and the camera position information;
the simulation apparatus making a determination of whether a maximum working distance is the largest straight distance from among straight distances from a position of the camera included in the camera position information to boundaries of the second UI region, or whether the maximum working distance is a diagonal distance of the second UI region;
the second user interfacer calculating the maximum working distance based on the map information;
the simulation apparatus configured to determine whether to only calculate the field of view limited by the maximum working distance or to calculate the field of view limited by an entire working distance of the camera; and
the second user interfacer calculating the field of view limited by the maximum working distance.

17. The simulation method of claim 1, further comprising:
determining whether the map image size is less than a threshold value or equal to or greater than the threshold value;
determining that the map image size is less than the threshold value wherein the second UI region corresponding to the second UI information has a size greater than or equal by a ratio of first value in comparison to the map image size;
determining that the map size is equal to or greater than the threshold value wherein the second UI region corresponding to the second UI information has a size greater than or equal by a ratio of second value in comparison to the map image size; and
wherein the second ratio is less than the first ratio.

18. The simulation apparatus of claim 9, wherein:
the simulation apparatus is configured to determine whether the map image size is less than a threshold value or equal to or greater than the threshold value;
the simulation apparatus is configured to determine that the map image size is less than the threshold value and the second UI region corresponding to the second UI information has a size greater than or equal by a ratio of first value in comparison to the map image size;
the simulation apparatus is configured to determine that the map size is equal to or greater than the threshold value and the second UI region corresponding to the second UI information has a size greater than or equal by a ratio of second value in comparison to the map image size; and
the second ratio is less than the first ratio.

19. The simulation apparatus of claim 16, wherein:
the simulation apparatus is configured to determine whether the map image size is less than a threshold value or equal to or greater than the threshold value;
the simulation apparatus is configured to determine that the map image size is less than the threshold value and the second UI region corresponding to the second UI information has a size greater than or equal by a ratio of first value in comparison to the map image size;
the simulation apparatus is configured to determine that the map size is equal to or greater than the threshold value and the second UI region corresponding to the second UI information has a size greater than or equal by a ratio of second value in comparison to the map image size; and
the second ratio is less than the first ratio.
